(19) United States
(12) Patent Application Publication
(10) Pub. No.: US 2014/0229574 A1
(43) Pub. Date: Aug. 14, 2014

(54) Unified Media Broadcasting and Communication System and Method

(71) Applicant: Paul Shirer, Ballwin, MO (US)

(72) Inventor: Paul Shirer, Ballwin, MO (US)

(73) Assignee: RED CLOUD DIGITAL, LLC, Ballwin, MO (US)

(21) Appl. No.: 14/343,023

(22) PCT Filed: Sep. 7, 2012
(86) PCT No.: PCT/US12/54271

§ 371 Date: Mar. 5, 2014

Related U.S. Application Data
(60) Provisional application No. 61/531,770, filed on Sep. 7, 2011.

(51) Int. Cl. H04L 12/24

(52) U.S. Cl. CPC H04L 41/509
USPC 709/217

(57) ABSTRACT

A unified media broadcasting and communication system is provided, comprising one or more servers for storing selected media and communication information managed by subscribers; an administration computer connected to the server for controlling access to the media and communication by subscribers; means for delivering the media and communication information to subscribers; wherein the media and communication information include video, e-learning, webcasts, conferencing, photos, file sharing, forums, articles, and blogs; and wherein the subscribers selectively provide the media and communication information to users.

### TECHNICAL FIELD

The present invention relates to systems and methods for unifying the authoring, promotion, selling, and broadcast of media, and management of communications across a wide area network, and more particularly to such systems and methods which are enabled for operation in a cloud environment.

### BACKGROUND OF THE INVENTION

Businesses and individuals have a constant need for delivering, sharing, and participating in a wide range of Internet-based activities, including videos, images, links, files, webinars, courses, and other media and communications. While there are a multitude of client-based and online software tools available to address one of more of those tasks, there remains a conspicuous absence of services which effectively unify each of those activities in a single, coherent, and easy to use system. With currently available methods, one must strive to integrate several different technologies, work with a number of vendors, or send users to many different places to accomplish basic tasks.

For example, in conventional media, content is typically presented as a page or a slide. The end result is a linear and rather inefficient approach to consuming and authoring information. The convention is to create headlines, flow in images, other graphics, etc., to convey meaning to a consumer. The Internet web page added video and links, but held to the conventions of the page. The slide, as seen in presentation software such as PowerPoint developed by Microsoft Corporation, tries to improve the user experience in terms of focus and palatable consumption of content, but, in the end, it is just collation of simple pages with some improved navigation. The result is a limited consumer experience and a limited authoring experience.

Current applications appear to lack a cohesive understanding of the similarities in all media types. For example, all media types have a title, description, thumbnail, keywords, can be categorized, commented on, shared, have ads, be sold and purchased, hosted on a cloud server, downloaded, and delivered through a media player. The only significant aspect that changes is the content viewer or type of media player. Otherwise, all media types are essentially the same. A new and innovative platform, such as the invention described herein, is architected with this in mind, improving its overall usability by the end user, its performance, cost efficiency, and scalability.

What is needed, therefore, is a system having a turn-key suite of features that communicates seamlessly with a user's own Internet web site to handle media promotion, media delivery, media tracking, webcasts, e-learning, file sharing, forums, conferencing, and related activities. Moreover, such a system should enable users to monetize these assets with integrated e-commerce functionality. The system should also provide a user management system in which users can create user accounts with profiles, and generate feedback such as comments and ratings related to media and other content. In addition, the system should enable such media and other content to be easily shared with popular social networks and media share web sites. Such a system should operate in a “cloud” environment, thus liberating the user from having to procure other computing or storage devices for administrating the aforementioned tasks. It is believed that the present invention meets all of the above requirements.

The present invention shifts the paradigm of how media is consumed by focusing on individual media assets or a collection of those media assets (referred to herein as “Object Media” or “Information Objects”). As will be demonstrated herein, it is more efficient, to the point, can be tracked, collected, collated, and searched in a more meaningful way. The present invention enables Information Objects that are more highly described or meaningful as they are positioned in the context of other Information Objects. This new system, therefore, redefines how information is assembled, managed, delivered, tracked and consumed. As a result, the system is the first platform to deliberately generate smarter, more efficient, and more relevant media. As media items are described individually and assembled with other media items by human beings, the relevance of the media together is more intelligent and semantic than a machine algorithm. In short, the system transcends “search indexing” and provides for “Intelligent Indexing”.

### SUMMARY OF THE INVENTION

Therefore, a unified media broadcasting and communication system and method are provided, comprising one or more servers for storing selected media and communication information managed by subscribers; an administration computer connected to the server for controlling access to the media and communication by subscribers; means for delivering the media and communication information to subscribers; wherein the media and communication information include video, e-learning, webcasts, conferencing, photos, file sharing, forums, articles, and blogs; and wherein the subscribers selectively provide the media and communication information to predetermined users. In a preferred embodiment, the system includes a web-based platform for authoring, organizing, managing, promoting, publishing, selling, consuming, tracking, and delivering online media, including video, images, files, links, webcasting, video conferencing, forums, articles, blogs, e-learning courses and/or a collection of various media. A method for providing the above described system as a service to subscribers is also described.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows a schematic diagram of the relationship between participants of the system in accordance with a preferred embodiment of the present invention

FIG. 2 shows a broad level service map of the various components of the present invention.

FIG. 3 shows a generalized architecture of the system in accordance with the present invention.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

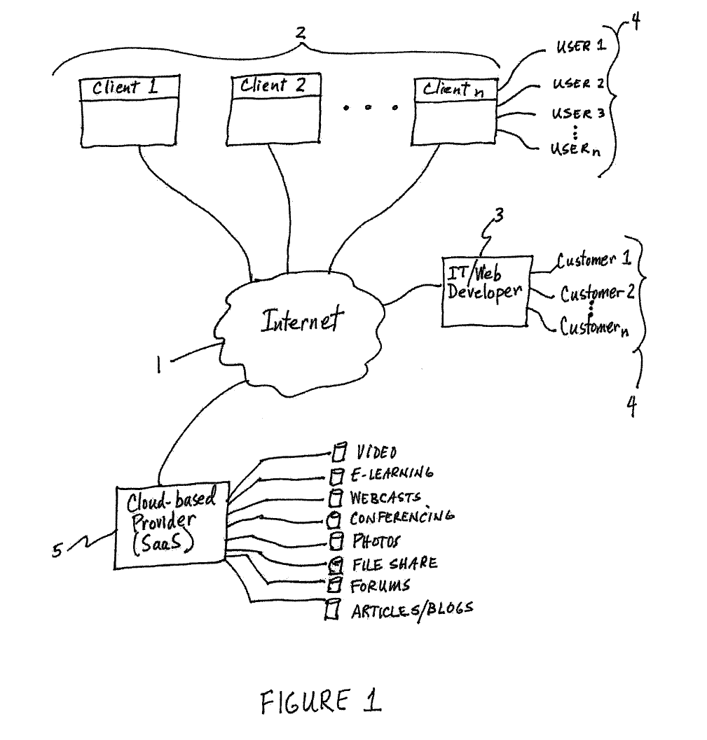

Turning now to FIG. 1, a generalized schematic diagram is shown depicting the relationship between various participants in the present invention. Consistent with cloud-based computing principles, the present invention embodies Software as a Service (SaaS) concepts, such that all participants, including clients and intermediate services providers (collectively, “users”), are in communication with a Provider 5 via the Internet 1. In other words, the Provider hosts the necessary software, and the users are not required to install or manage software or purchase hardware for using the Provider's web-based software application as a service.

With respect to FIG. 1, a number of direct clients 2 may subscribe to the Provider's services, as well as other intermediate service providers, such as information technology (IT) or web developers 3, who in turn provide those services to their downstream customers 4.

The Provider's infrastructure, hardware, and software provide for a number of servers 6 that control activities and/or store data most important to the subscribed Clients, specifically video, e-learning, webcasts, conferencing, photos, file sharing, forums, news, and related features.

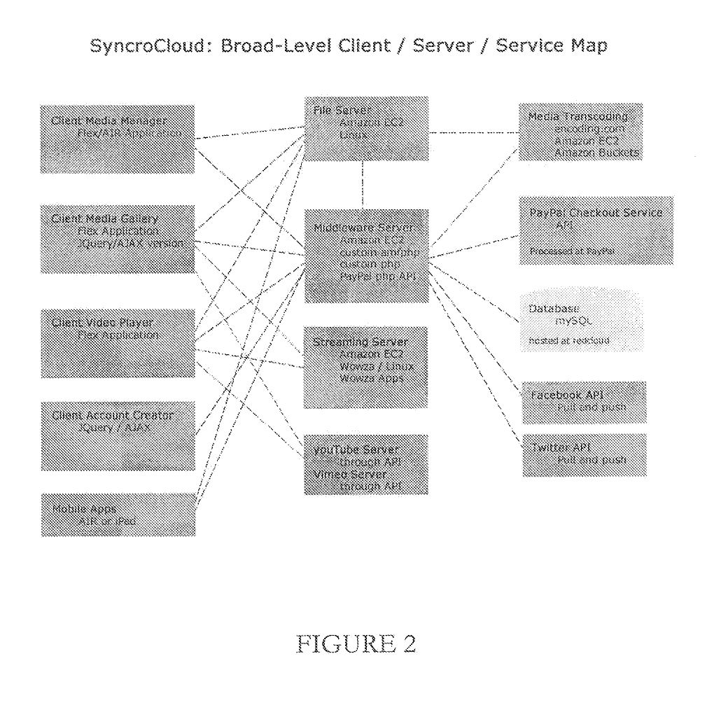

Referring now to FIG. 2, a broad level map of the Provider's service is shown, specifically in connection with the media management functions. For example, a client media manager is designed to communicate with a file server and middleware server, which in turn are in communication with higher lever components, including media transcoding functions, checkout services, SQL databases, and other social networking API's. Similarly, a client media gallery is in communication with other file servers and any number of streaming media servers. Client video players are likewise in communication with the above components for displaying media content as known in the art. Client account management features are provided for creating and managing user accounts. Importantly, mobile applications for wireless devices are also provided to enable users to manage media.

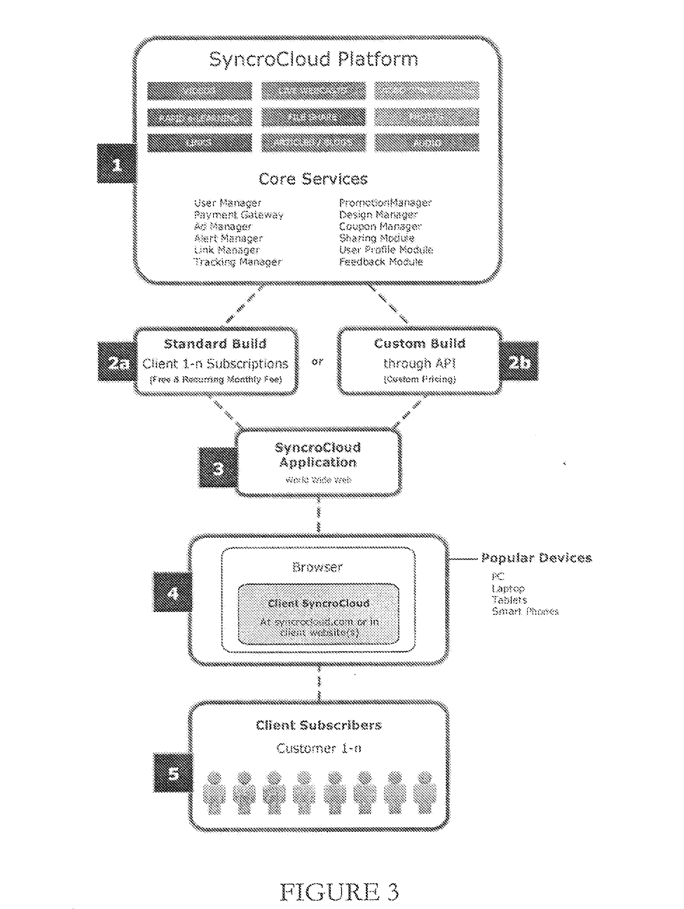

With respect to FIG. 3, a generalized architecture of the system of the present invention is shown, depicting file servers required for storing and delivery information to clients. A number of core services are provided and in communication with the services, including a user manager, payment gateway, ad manager, link manager, tracking manger, promotion manager, design manager, coupon manager, sharing module, user profile module, and feedback module. Building upon the above components, the system includes a number of key user applications which are provided via the SaaS model described earlier herein, such as: (1) unified media suite, (2) video player and manager, (3) media collections site, (4) mobile meeting, (5) mobile webcasts, (6) mobile media, and (7) mobile learning.

With respect to one of the primary features of the invention, the client media manager includes a wide range of functions that enable the user to accomplish all tasks related to media intended for delivery to others. For example, a number of media or information items can be managed, including photos, images, video, e-seminars, courses, meetings, files, audio, links, and forums. Additional items may also include quizzes, surveys, certificates, and related items. All of the various items may be edited with respect to title, keywords, descriptions as desired. Item-level passwords may also be applied, and access may be controlled based on certain users or groups. With respect to e-seminars, the user can provide instructions and/or resources on how to setup and conduct a seminar. These and many other features are available to the end user or developer as identified in Appendix A attached hereto.

Similar, the client media gallery provides numerous functions which enable the user to manage collections of media and other items, administrate an e-commerce system for content delivery, and create and modify user account attributes. These and many other features are available to the end user or developer as identified in Appendix B attached hereto.

With the above Provider servers and applications in place, it will be appreciated that numerous features and advantages can be realized. For example, users can upload videos from a computer, or insert embed code from video sites, such as youTube and other streaming media sites. Uploaded video can be low-quality for mass distribution or HD, premium-level quality to be delivered like a movie. Users can also broadcast live to small or large groups with the webcasting tool, featuring a multiple-camera feed, a high-end camera feed, user text chat, login list, user questions, user polling, whiteboard, screen-share, flash presentations, presenter notes, file share, and link share. Similarly, users can conduct online meetings and e-learning events with concurrent webcams, screen-share, file share, chat, live, notes, and a whiteboard.

With the integrated e-commerce functionality, a price can be set for each item or simply allow it to be delivered at no charge. Payment processing can be handled through well-known services such as PayPal and others. Thus, consumers of the media delivered from users are able pay for media directly in one step.

Media items can also be directly promoted to others through a direct-linking capability. Also, the system enables the user to easily inform other about such media items through built-in share-ability with popular social media sites using a one-push feature to populate Twitter and Facebook accounts. Moreover, with a webcam, the user can deliver a promotional message about a media item, e.g. a just-launched course, upcoming webinar, a recently added video, etc. When others view the user's video mail, the link takes them to a landing page specifically created for that media item. From that location, the viewer can learn more, purchase the item, make a donation, or take other actions related to that item.

Each media item may also be monetized through advertising sponsorship. For example, each item can display its own banner ad along with the name and link of the ad sponsor.

For ease of use, and avoidance of using multiple vendors for common tasks, a video player, webcasting platform, video meeting, and course module are seamlessly integrated into the system. Thus, the user is better able to quickly prepare media content, designate its characteristics, and manage its delivery specifics, all within one system.

Given the cloud nature of the system, the user can easily embed the Provider's system directly into their own site or blog. The same “thin” embed code can be placed in any number of other sites as desired by the user managing the media items.

### EXAMPLE 1

### Political Campaigns

It will be appreciated that there are many possible businesses and industries which can derive tremendous benefits from the present invention. However, it will be helpful to elaborate on the invention's features in the context of at least one specific case, e.g. political campaigns. Using the present invention as the creative platform, campaigns can easily and cost-effectively manage, promote, deliver, and sell popular online media from their own website or at the website of the Provider. Large national political campaigns are often well-staffed with media-savvy personnel familiar with the process of delivery e-content to potential voters. However, some campaigns are quite local and small, and they do not have the resources to prepare and deliver media content with the same speed and quality as others. In either case, the present invention is quick to set up, requires no software downloads, and needs no IT staffing to accomplish most tasks.

In effect, this robust platform levels the playing field and empowers the “little guy” by removing the current high cost and major IT hurdles currently associated with these types of technologies. Utilizing only one passcode, campaigns can now harness the full potential of the Internet and engage with target audiences using rich media, such as video mail, video conferences, webcasts, courses and presentations, multimedia galleries, articles, blogs, forums, and file transfers.

For example, in the case of video mail, Campaigns can now easily generate an effective and targeted video email marketing campaign to connect with key stakeholders (donors, voters, press, etc.) in a much more powerful and personal way than standard email. When users view the video email, they arrive at a landing page specifically created and designed for the media item. With active links positioned on the page, they can learn more, purchase an item, or make a donation instantly. A built-in payment gateway means that inspired viewers can purchase or donate without leaving the system to complete the transaction.

The video mail feature allows campaigns to call supporters to action much easier than by conventional methods. It enables any campaign to recruit, organize and activate supporters by promoting upcoming events, such as rallies, press conferences, town hall meetings, fundraisers, election day GOTV initiates, and the like.

Fundraising is also enhanced with custom click-through links and a built-in payment gateway that enables voters to easily donate and spread the word in the moment. Also, a built-in advertising feature allows campaigns to attract sponsors who can display banner ads to all email recipients.

Campaigns can deliver any and all campaign ads and videos to voters quickly and easily. The one-touch click-through links enable recipients to instantly forward ads and other videos throughout their social networks, increasing the likelihood of the campaign messages going viral. Furthermore, this easy distribution of video allows campaigns to respond immediately to opposition or media attacks. Campaigns will no longer be at the mercy of production, editing and TV airing schedules in order to counter-attack or set the record straight.

Every campaign struggles to keep itself focused and organized. With the present invention, responding quickly to rapidly changing conditions is easier and more effective, ensuring that key stakeholders remain engaged. Integrated video conferencing can be initiated from any computer with a webcam. Thus, campaigns now have the ability to instantly and easily communicate with many field and office staffers “on the fly” from virtually any location. With features such as desktop and document share, candidates or managers can educate, update, organize and motivate staffers like never before.

Similarly, virtual Town Hall meetings can be initiated from any computer with a webcam. An effective campaign requires that the candidate or issue remain at the forefront of voters' minds, especially in a crowded or heated race. The present invention enables a campaign to easily schedule and initiate webcasts as often as necessary to stay connected to voters anywhere and to drive its message(s) in a more effective way through by fundraising initiatives, recruiting of volunteers, and GOTV drives. The number of webcast viewers is virtually unlimited and with features such as polling, campaigns will be able to measure voter sentiment by getting real time feedback. Additionally, internal tracking will continuously broaden a campaign's voter reach by capturing participants' contact info during the sign-up process.

The e-learning features of the present invention allow easy assembly of a “course” on the candidate or issue. Campaigns can introduce the candidate or ballot issue to voters in a more compelling and dynamic way. Non-technical individuals are provided with a streamlined process to incorporate video, audio, photos, documents, presentations, and links into an engaging, online learning experience. For a campaign, it means the ability to educate and connect with voters faster and with high quality content. Utilizing these various rich media, campaigns can quickly and easily assemble and present its platform in a unified flow-line format. This method of delivering information educates voters in a much more dynamic, engaging and interactive way, and enables voters to know candidates or issues far more intimately.

Through the media gallery feature, campaigns can promote and/or sell digital media. The present invention allows campaigns to load and manage its media through an easy-to-use content management system with no prior technical expertise. The user can give a media item a title, description, keyword for searchability, and even set the dates that it is available.

Furthermore, the system comes equipped with fundraising tools that enable campaigns to monetize their media. Considering the time, effort and resources that a campaign will spend during any given election cycle, numerous advertisers could be attracted to tap into that kind of reach. The invention allows ads to be placed on any media item (videos, webcasts, etc.) so campaigns can monetize its media through sponsorships.

Campaigns often struggle to break through all of the noise and confusion of an election cycle. Races are becoming increasingly crowded, which may make it difficult for smaller campaigns to establish a significant presence and relevance to voters. The system enables any campaign to seize a leadership position on the big issues. By the integrated content management system, campaigns can easily post articles and blogs on their official website, while voters are free to post their comments twenty-four hours a day. This keeps voters informed of the campaign's position on important issues, but also keeps them engaged directly with the campaign. Over the course of the race, this will position the campaign to lead on more issues. Furthermore, it will drive more voters to the site and will allow the campaign to capture more voter information. The ever-increasing voter database will, of course, better enable the campaign to directly target more constituents for contributions and votes.

It is critical that a campaign not get so bogged down internally that it becomes inadvertently tone deaf. Online discussion forums are an important part of ongoing collaborative learning; for both the campaign and the voters. Campaigns will create a space of free-flowing dialogue where participants can read other responses and post their own around important topics that the campaign staff can create and manage. The present invention enables campaigns to effectively tap into voter sentiment and discover what voters want and expect in a very targeted way. This, of course, would allow campaigns to refine their message accordingly.

Any large media items can be transferred easily from the campaign website on demand without any third-party assistance. The present invention allows any media item, including PDF's, PowerPoints and Flash slide shows to be made available for download through the Media Gallery. Campaigns can now simply direct any vender to retrieve any media item at will; greatly saving time, effort and expense.

As will be appreciated, the specific case of political campaigns provides a practical view to the features and advantages of the present invention over the array of disparate software tools otherwise available to users. Of course, many other industries, businesses, and commercial applications may equally derive benefit from the functionality described herein.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

What is claimed is:

1. A unified media broadcasting and communication system, comprising:
(a) one or more servers for storing selected media and communication information managed by subscribers;
(b) an administration computer connected to the server for controlling access to the media and communication by subscribers;
(c) means for delivering the media and communication information to subscribers;
(d) wherein the media and communication information include video, e-learning, webcasts, conferencing, photos, file sharing, forums, articles, and blogs; and
(e) wherein the subscribers selectively provide the media and communication information to users.

2. A method for providing a unified media broadcasting and communication service, comprising:
(a) providing one or more servers for storing selected media and communication information managed by subscribers;
(b) providing an administration computer connected to the server for controlling access to the media and communication by subscribers;
(c) providing means for delivering the media and communication information to subscribers;
(d) wherein the media and communication information include video, e-learning, webcasts, conferencing, photos, file sharing, forums, articles, and blogs; and
(e) wherein the subscribers selectively provide the media and communication information to users.
